(19) United States
(12) Patent Application Publication
(10) Pub. No.: US 2006/0144175 A1
(43) Pub. Date: Jul. 6, 2006

(54) Engine starter equipped with torque absorber

(75) Inventors: Yukio Nawa, Gifu-shi (JP); Sadayoshi Kajino, Nagoya (JP); Youichi Hasegawa, Kasugai-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/303,957

(22) Filed: Dec. 19, 2005

(30) Foreign Application Priority Data
Dec. 17, 2004 (JP) 2004-366375
Dec. 20, 2004 (JP) 2004-368109

(51) Int. Cl. F02N 15/02

(52) U.S. Cl. 74/7 C

(57) ABSTRACT

A starter for automotive engines is provided which is equipped with a planetary gear speed reducer and a torque impact absorber. The torque impact absorber is made up of an outer cylindrical shell and an internal gear of a planetary gear train. The outer cylindrical shell has formed thereon a plurality of lock protrusions which are fitted in a starter casing to keep the outer cylindrical shell from rotating. The protrusions extend in an axial direction of the starter, thus permitting the size of the starter to be decreased.

### CROSS REFERENCE TO RELATED DOCUMENT

The present application claims the benefits of Japanese Patent Application No. 2004-366375 filed on Dec. 17, 2004, and Japanese Patent Application No. 2004-368109 filed on Dec. 20, 2004, disclosures of which are incorporated herein by reference.

### BACKGROUND OF THE INVENTION

1. Technical Field of the Invention

The present invention relates generally to a starter which may be employed in starting an automotive engine, and more particularly to such a starter equipped with a planetary gear speed reducer working to reduce the speed of rotation of an electric motor and transmit it to a starter output shaft for cranking the engine and a torque absorber working to absorb an excess of torque arising from, for example, meshing of a pinion on the starter output shaft with a ring gear connected to the engine.

2. Background Art

Japanese Patent No. 3499177 (U.S. Pat. No. 6,222,293 B1) discloses an engine starter equipped with a planetary gear speed reducer. The starter also includes an impact absorber implemented by an outer ring fitted on an outer periphery of an internal gear of a planetary gear speed reducer. The outer ring has a pair of diametrically opposed lock protrusions formed on an outer periphery thereof. The lock protrusions are fitted in grooves formed in a starter casing to retain the outer ring from rotating. The outer ring is placed in frictional engagement with the outer periphery of the internal gear so that it allows the internal gear to rotate or slip relative to the outer ring when torque which arises from meshing of a pinion on a starter output shaft with a ring gear connected to the engine and acts on the internal gear exceeds a selected value (which will be referred to as a slip torque below), thereby absorbing the impact caused by input of such excessive torque.

The impact absorber has the advantages that a desired degree of the slip torque is achieved easily as compared with a conventional structure in which an end surface of the internal gear is urged into abutment with an inner wall of the starter casing through an elastic member.

The starter equipped with such an impact absorber, however, has the drawback in that the outer diameter of the planetary gear train is increased by the thickness of the outer ring, thus resulting in an overall size or weight of the starter.

### SUMMARY OF THE INVENTION

It is therefore a principal object of the invention to avoid the disadvantages of the prior art.

It is another object of the invention to provide a compact, lightweight, or easy-to-machine structure of a starter equipped with a planetary gear speed reducer and an impact absorber.

According to one aspect of the invention, there is provided a starter which may be employed in starting an automotive engine. The starter comprises: (a) a casing; (b) an electric motor disposed within the casing, the motor having an output shaft; (c) a one-way clutch disposed frontward of the motor within the casing; (d) a planetary gear train disposed between the motor and the one-way clutch within the casing, the planetary gear train working as a speed reducer to reduce a speed of rotation of the output shaft of the motor to transmit torque of the output shaft to the one-way clutch; (e) a starter output shaft retained in the casing rotatably for outputting the torque of the output shaft of the motor, as transmitted through the one-way clutch; and (f) an outer cylindrical member so fitted on an outer peripheral surface of an internal gear of the planetary gear train as to establish frictional engagement therewith when torque applied to the internal gear is less than a given value. The outer cylindrical member includes a hollow cylindrical body and lock protrusions. The lock protrusions extend in an axial direction of the outer cylindrical member from a front end of the cylindrical body oriented toward the one-way clutch. The lock protrusions are arrayed at given angular intervals in a circumferential direction of the cylindrical body and fitted in grooves formed in an inner peripheral wall of the casing, thereby locking the outer cylindrical member to the casing.

The lock protrusions, as described above, extend from the front end of the cylindrical body of the outer cylindrical member, thereby allowing the outer cylindrical member or the casing to be decreased in diameter as compared with the conventional structure, as discussed in the introductory part of this application. This also results in a decrease in overall size or weight of the starter. The lock protrusions may reach outside the one-way clutch in a radius direction of the one-way clutch.

The lock protrusions are located away from an inner peripheral surface of the cylindrical body of the outer cylindrical member which is in frictional contact with the internal gear. Therefore, when an excessive torque acting on the inner peripheral surface of the cylindrical body, it results in twisting thereof to absorb the torque.

In the preferred mode of the invention, the number of the lock protrusions is greater than or equal to that of planet gears of the planetary gear train. For instance, the three lock protrusions are formed on the outer cylindrical member.

The inventors of this application performed tests on the starter, as taught in Japanese Patent No. 3499177 discussed in the introductory part of this application, to examine factors of variation in the slip torque of the internal gear of the planetary gear train and partial wear of surfaces of contact between the outer ring and the internal gear. This will be described below.

Usually, some of the inner teeth of the internal gear receive torque from the planetary gears through engagement therebetween. In other words, the torque acting on the planet gears is transmitted to only part of the teeth of the internal gear. Such torque is finally transmitted from the internal gear to the starter casing through the lock protrusions. When subjected to the torque, the outer ring is deformed inward or outward, thereby resulting in a change in circularity thereof. Such a change will lead to a variation in the sip torque, thus resulting in the partial wear of the surfaces of contact between the outer ring and the internal gear or a change in the slip torque. In order to avoid this problem, the starter of this invention is designed to have the lock protrusions greater in number than or equal to the planet gears on the outer cylindrical ring which are arrayed at the given angular intervals in the circumferential direction of the outer cylindrical member. Specifically, adjacent two of the lock protrusions located close to one of the planet gears outputting the torque serve to share transmission of the torque to the starter casing, thus resulting in decreased deformation of the outer cylindrical member in the radial direction thereof. The formation of a lot of the lock protrusions permits the outer cylindrical member to be reduced in thickness, thus resulting in a decrease in overall size or weight of the starter. Further, the degree of torque born by each of the lock protrusions will be smaller than that in the conventional structure, thus permitting the length of the lock protrusions in the axial direction of the outer cylindrical member to be shortened.

The cylindrical body of the outer cylindrical member may include a main body, an annular extension, an inner flange, and a stopper member. The annular extension extends in the axial direction of the outer cylindrical member from a front end of the main body oriented toward the one-way clutch. The inner flange extends inwardly from a rear end of the main body in abutment with a rear end surface of the internal gear. The stopper member is fitted on an inner peripheral wall of the annular extension to hold the internal gear from moving in the axial direction within the main body.

The cylindrical body of the outer cylindrical member may include an inner flange and a washer. The inner flange extends inwardly from a rear end of the cylindrical body in abutment with a rear end surface of the internal gear. The washer is in engagement with the inner peripheral wall of the casing to hold the internal gear from moving in the axial direction within the cylindrical body.

The casing may include a front case, a center case, and an end case in which the motor is disposed. The washer has a lock protrusion. The lock protrusions of the washer and the outer cylindrical member are urged into constant abutment with end walls of the grooves formed in the casing by fastening a through bolt to joint the end case to the center case firmly.

The inner flange may have an inner edge located outside radially outward ends of planet gears of the planetary gear train. The rear ends of the planet gears protrude rearward from the rear end surface of the internal gear and are located at least frontward of a rear end surface of the inner flange.

One of the cylindrical body of the outer cylindrical member and the internal gear may include a central contact surface and fitting guide surfaces continuing from the central contact surface in axial opposite directions of the one of the cylindrical body and the internal gear. The central contact surface is in frictional contact with other of the cylindrical body and the internal gear. The fitting guide surfaces are tapered to guide fitting of the internal gear into the outer cylindrical member.

The central contact surface and the fitting guide surfaces may be coated with a solid lubricating layer.

The length of each of the fitting guide surfaces may be so selected as to establish a slip torque which causes the internal gear to slip on the outer cylindrical member when the slip torque is applied to the internal gear.

The inventors of this application studied the structure of the starter, as taught in Japanese Patent No. 3499177 discussed in the introductory part of this application, and found that the lack of thickness of the outer ring results in a variation in the slip torque of the internal gear of the planetary gear train or partial wear of surfaces of contact between the outer ring and the internal gear for the following reasons.

The transmission of torque from the planet gears, to the internal gear, to the outer ring, and to the starter casing will be described below with reference to FIGS. 14 and 15.

Number 100 denotes the planet gears. Number 101 denotes the internal gear, Number 102 denotes the outer ring. Numbers 103a and 103b denote the lock protrusions. Number 104 denotes a center case that is a part of the starter casing. Number 105 denotes grooves formed in the center case 104 in which the lock protrusions 103a and 103b are fitted. For the brevity of explanation, the following discussion will refer only to a central one of the planet gears 100 located between the lock protrusions 103a and 103b, as illustrated in FIG. 14.

The planet gear 100 urges the internal gear 101 in a circumferential direction Y at point X indicating one of teeth of the internal gear 101 on which the torque is exerted from the planet gear 100. This causes an arc section of the outer ring 102 between the planet gear 100 and the lock protrusion 103a to bulge in an outward direction A and another arc section between the planet gear 100 and the lock protrusion 103b to bulge in an inward direction B, thus resulting in a change in circularity of the outer ring 102. Such a change will result in a change in pressure acting on areas of contact between the outer ring 102 and the internal gear 101, which leads to a change in the slip torque or wear of the inner peripheral wall of the outer ring 102.

Specifically, when a large-scale torque impact acts on the internal gear 101 of the planetary gear train, it will cause the bending stress to be applied to the outer ring 102 in the radial direction thereof. The slip torque of the internal gear is known to be proportional to a product of the amount of pressure acting on a contact between the internal gear 101 and the outer ring 102 (i.e., contact pressure) and an area of contact. The bending stress, therefore, results in a change in the contact pressure and leads to a change in the slip torque.

The inventors found that the cause of the change in the slip torque or the wear of the outer ring 102 lies on the fact that a lack of the number of the lock protrusions 103a and 103b will result in an increased angle between one of teeth of the internal gear (i.e., the point X) on which the torque is exerted from the planet gear 100 and either of the lock protrusions 103a and 103b, thus causing the orientation of force exerted on the outer ring 102 to change greatly to induce the deformation of the outer ring 102 in the outward or inward direction.

In order to avoid the above problem, there is provided a starter which comprises: (a) a casing having fit-features; (b) an electric motor disposed within the casing, the motor having an output shaft; (c) a one-way clutch disposed frontward of the motor within the casing; (d) a planetary gear train disposed between the motor and the one-way clutch within the casing, the planetary gear train working as a speed reducer to reduce a speed of rotation of the output shaft of the motor to transmit torque of the output shaft to the one-way clutch; (e) a starter output shaft retained in the casing rotatably for outputting the torque of the output shaft of the motor, as transmitted through the one-way clutch; and (f) an outer cylindrical member so fitted on an outer peripheral surface of an internal gear of the planetary gear train as to establish frictional engagement therewith when torque applied to the internal gear is less than a given value. The outer cylindrical member includes an outer peripheral surface which has mating fit-features establishing fits with the fit-features of the casing to achieve a joint between the outer cylindrical member and the casing. The mating fit-features are more in number than or equal to planet gears of the planetary gear train and arrayed at a given interval away from each other in a circumferential direction of the outer peripheral surface.

Specifically, the structure of the starter has a lot of the mating fit-features (e.g., lock protrusions). The angle, as illustrated in FIG. 15, between one of teeth of the internal gear (i.e., the point X) on which the torque is exerted from the planet gear 100 and either of the mating fit-features 103c to which the torque is inputted is, thus, decreased as compared with the one in FIG. 14. This cause the torque transmitted to the outer cylindrical member 202 to be delivered to the mating fit-features 103c located across the point X, thereby reducing the bending stress acting on the outer cylindrical member 202.

In the preferred mode of the invention, the interval between adjacent two of the mating fit-features may be substantially identical with a pitch of teeth of the internal gear of the planetary gear train.

Each of the mating fit-feature of the outer cylindrical member may be made of a protrusion of a gear tooth shape.

The outer cylindrical member is made of an outer thermally hardened layer, an inner thermally hardened layer, and a non thermally hardened layer between the outer and inner thermally hardened layers. The outer and inner thermally hardened layers define the outer peripheral surface and an inner peripheral surface of the outer cylindrical member, respectively. The non thermally hardened layer has a thickness which is one to two times that of each of the outer and inner thermally hardened layers.

The outer cylindrical member may have an inner flange which extends inward from a front end thereof and works as a stopper to retain the internal gear from moving frontward in an axial direction of the internal gear.

The internal gear may alternatively have an outer which extends outward from a front end thereof and works as a stopper to retain the internal gear from moving frontward in an axial direction of the internal gear.

According to another aspect of the invention, there is provided a starter which comprises: (a) a casing having fit-features; (b) an electric motor disposed within the casing, the motor having an output shaft; (c) a one-way clutch disposed frontward of the motor within the casing; (d) a planetary gear train disposed between the motor and the one-way clutch within the casing, the planetary gear train working as a speed reducer to reduce a speed of rotation of the output shaft of the motor to transmit torque of the output shaft to the one-way clutch; (e) a starter output shaft retained in the casing rotatably for outputting the torque of the output shaft of the motor, as transmitted through the one-way clutch; and (f) an outer cylindrical member so fitted on an outer peripheral surface of an internal gear of the planetary gear train as to establish frictional engagement therewith when torque applied to the internal gear is less than a given value. The outer cylindrical member includes an outer peripheral surface which has mating fit-features establishing fits with the fit-features of the casing to achieve a joint between the outer cylindrical member and the casing. One of an inner peripheral wall of the outer cylindrical member and an outer peripheral wall of the internal gear includes a central contact surface and fitting guide surfaces continuing from the central contact surface in axial opposite directions of the one of the outer cylindrical member and the internal gear. The central contact surface is in frictional contact with other of the outer cylindrical member and the internal gear. The fitting guide surfaces are tapered to guide fitting of the internal gear into the outer cylindrical member. The central contact surface and the fitting guide surfaces are coated with a solid lubricating layer.

The tapered fitting guide surfaces serve to minimize the possibility of damage to the outer cylindrical member and the internal gear when the internal gear is fitted in the outer cylindrical member. The use of the solid lubricating layer the need for holding grease or a lubricant supplying mechanism which are required in the conventional structure.

In the preferred mode of the invention, the length of each of the fitting guide surfaces is so selected as to establish a slip torque which causes the internal gear to slip on the outer cylindrical member when the slip torque is applied to the internal gear.

According to the third aspect of the invention, there is provided a starter which comprises: (a) a casing having fit-features and an inner shoulder; (b) an electric motor disposed within the casing, the motor having an output shaft and a yoke, the yoke being joined at an end thereof to the casing by a through bolt; (c) a one-way clutch disposed frontward of the motor within the casing; (d) a planetary gear train disposed between the motor and the one-way clutch within the casing, the planetary gear train working as a speed reducer to reduce a speed of rotation of the output shaft of the motor to transmit torque of the output shaft to the one-way clutch; (e) a starter output shaft retained in the casing rotatably for outputting the torque of the output shaft of the motor, as transmitted through the one-way clutch; (f) an outer cylindrical member so fitted on an outer peripheral surface of an internal gear of the planetary gear train as to establish frictional engagement therewith when torque applied to the internal gear is less than a given value, the outer cylindrical member including an outer peripheral surface which has mating fit-features establishing fits with the fit-features of the casing to achieve a joint between the outer cylindrical member and the casing; (g) a first washer disposed between the inner shoulder of the casing and front ends of the internal gear of the planetary gear train and the outer cylindrical member; and (h) a second washer disposed between rear ends of the outer cylindrical member and the internal gear and the end of the yoke of the motor. The second washer is urged by the end of the yoke to place the front ends of the internal gear and the outer cylindrical member in constant abutment with a surface of the inner shoulder through the first washer.

Use of the washers ensures the stability of location of the internal gear and the outer cylindrical member and results in a simple structure of the starter.

In the preferred mode of the invention, the second washer works to bear a backward thrust load, as transmitted from the starter output shaft to support pins which support the planet gears rotatably and extend from an outer of the one-way clutch backward in an axial direction of the one-way clutch.

### BRIEF DESCRIPTION OF THE DRAWINGS

The present invention will be understood more fully from the detailed description given hereinbelow and from the accompanying drawings of the preferred embodiments of the invention, which, however, should not be taken to limit the invention to the specific embodiments but are for the purpose of explanation and understanding only.

In the drawings:

FIG. 1 is a partially cutaway view which shows a starter according to the first embodiment of the invention;

FIG. 2 is a partially enlarged sectional view which shows a planetary gear train and an outer cylindrical shell installed in the starter of FIG. 1;

FIG. 3 is a perspective view which shows the outer cylindrical shell of FIG. 2;

FIG. 4 is a partially sectional view which shows fitting of lock protrusions on an outer cylindrical shell with grooves formed in a center case of the starter in FIG. 1;

FIG. 5 is a partially enlarged sectional view which shows modified structures of the outer cylindrical shell and the internal gear, as illustrated in FIG. 2;

FIG. 6 is a partially sectional view which shows a starter according to the second embodiment of the invention;

FIG. 7 is a partially enlarged sectional view which shows a planetary gear train and an outer cylindrical shell installed in a starter according to the third embodiment of the invention;

FIG. 8 is a partially transverse sectional view which shows fitting of lock protrusions of an outer cylindrical shell and grooves in a center case of the starter of FIG. 7;

FIG. 9 is a graph which shows a relation between a permissible range of slip torque of an internal gear of a planetary gear train and an interference between an outer cylindrical shell and the internal gear;

FIG. 10 is a partially enlarged sectional view which shows a planetary gear train and an outer cylindrical shell installed in a starter according to the fourth embodiment of the invention;

FIG. 11 is a partially enlarged sectional view which shows structures of the outer cylindrical shell and the internal gear, as illustrated in FIG. 10;

FIG. 12 is a partially enlarged sectional view which shows a planetary gear train and an outer cylindrical shell installed in a starter according to the fifth embodiment of the invention;

FIG. 13 is a partially enlarged sectional view which shows a planetary gear train and an outer cylindrical shell installed in a starter according to the sixth embodiment of the invention;

FIG. 14 is a partially schematically sectional view which shows a structure of a planetary gear train of a conventional starter for explanation of deformation of an outer ring fitted on an internal gear of a planetary gear train arising from input of excessive torque; and

FIG. 15 is a partially schematically sectional view which shows a structure of a planetary gear train of a starter of the invention for explanation of deformation of an outer cylindrical member fitted on an internal gear of a planetary gear train arising from input of excessive torque.

### DESCRIPTION OF THE PREFERRED EMBODIMENTS

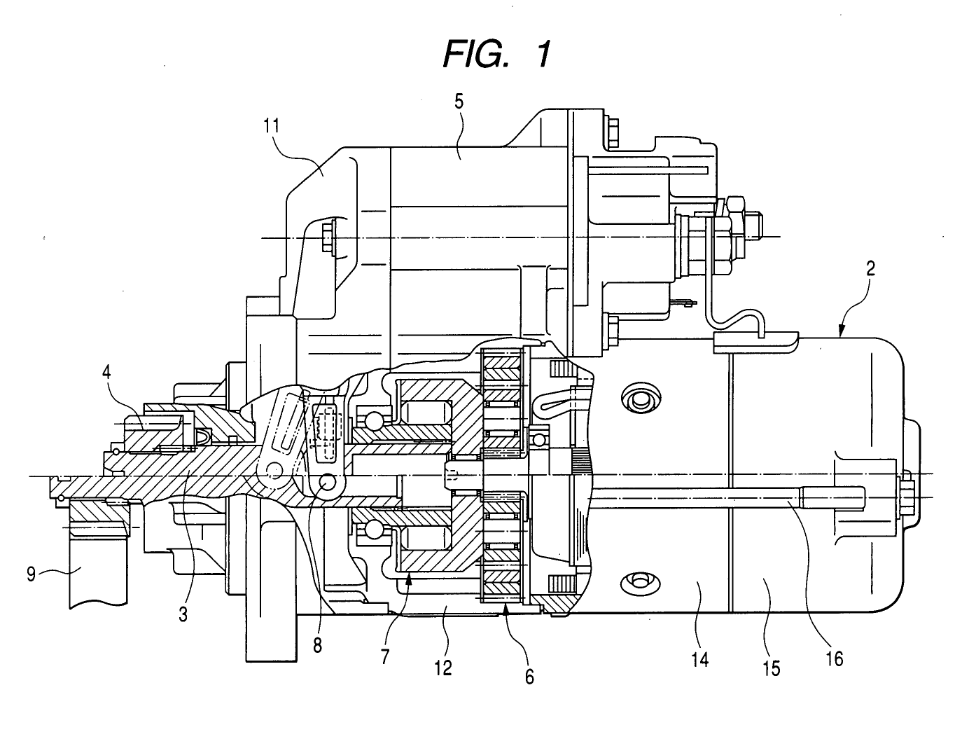

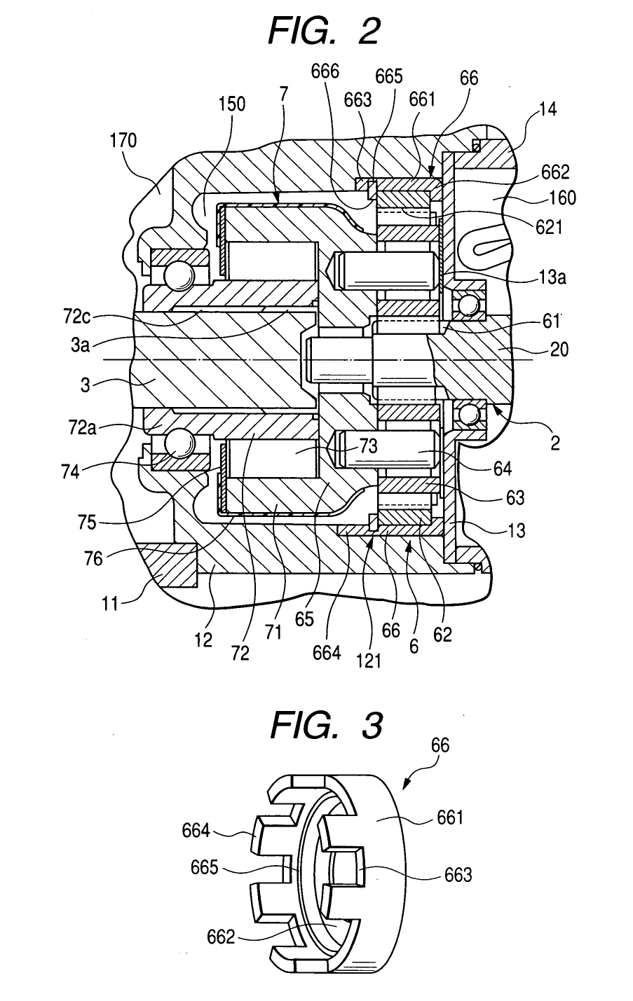

Referring to the drawings, wherein like reference numbers refer to like parts in several views, particularly to FIGS. 1 and 2, there is shown a starter 1 according to the first embodiment of the invention which may be employed in starting an automotive engine.

The starter 1 consists essentially of an electric motor 2, a starter output shaft 3, a pinion gear 4, a magnet switch 5, a planetary gear train 6, an one-way clutch 7, and a shift lever 8. The pinion gear 4 is movable into engagement with a ring gear 9 connected to an engine (not shown).

The starter 1 also has a starter housing within which the above component parts are fabricated. The starter housing is made up of a cup-shaped front frame 11 having an open rear end, a center case 12, a cylindrical partition plate 13 with a flange, a partition plate 13, a hollow cylindrical yoke 14 with open ends, and a cup-shaped end frame 15 with an open rear end. These components are joined in alignment to define a length of the starter 1. The center case 12 has defined in an upper portion thereof a switch chamber with an open rear end within which the magnet switch 5 is disposed and in a lower portion thereof a torque transmission mechanism chamber 150 with an open rear end within which the planetary gear train 6 and the one-way clutch 7 are disposed. The yoke 14 and the end frame 15 have defined therein a motor chamber 160 within which the motor 2 is disposed.

The front frame 11 and the end frame 15 are joined together by through-bolts 16 to retain the center case 12 and the yoke 14 therebetween in alignment. This holds the partition plate 13 between the center case 12 and the yoke 14 to block between the torque transmission mechanism chamber 150 of the center case 12 and the motor chamber 160 of the yoke 14.

The front frame 11 has defined therein a shift lever chamber 170 within which the shift lever 8 is disposed. Within the torque transmission mechanism chamber 150 of the center case 12, the planetary gear train 6 and the one-way clutch 7 are disposed. Within the switch chamber of the center case 12, the magnet switch 5 is disposed. Within the motor chamber defined by an assembly of the yoke 14 and the end frame 15, the motor 2 is disposed.

The motor 2 is a dc motor which includes an output shaft 20. The output shaft 20 is retained rotatably by the partition plate 13 and the end frame 15 through a bearing. The yoke 14 has a field winding and an armature disposed therein. The end frame 15 has a commutator and brushes disposed therein. The yoke 14 is made of a stationary iron member serving to form a part of a magnetic circuit of the motor 2. The armature and the commutator are fixed on the output shaft 20 of the motor 2. The output shaft 20 has an end extending through the partition plate 13 into the torque transmission mechanism chamber 150 of the center case 12. The motor 2 is of the structure known in itself and explanation thereof in detail will be omitted here.

The planetary gear train 6 is disposed in the lower portion of the center case 12 adjacent the partition plate 13. The planetary gear train 6 serves as a speed reducer and is made up of a sun gear 61, a ring-shaped internal gear 62, planet gears 63, support pins 64 (also called planet gear pins), a carrier 65, and an outer cylindrical shell 66. The sun gear 61 is formed on the end of the output shaft 20 of the motor 2. The outer cylindrical shell 6 is fitted in the center case 12 to retain the internal gear 62 firmly. The planet gears 63 are placed in mesh with the gears 61 and 62. The carrier 65 bears the planet gears 63 through bearings fitted on the support pins 64 installed in the planet gears 64. The planetary gear train 6 works to reduce a rotational speed of the output shaft 20 of the motor 2 to an orbital speed of the planet gears 63. Each of the planet gears 63 is supported rotataby by one of the support pins 64. The support pins 64 are press fit in holes formed in the carrier 65. The carrier 65 is also designed as a clutch outer 71, as will be described later in detail. The outer cylindrical shell 66 is a feature of this embodiment, and explanation thereof in detail will be made later.

The one-way clutch 7 is, as clearly shown in FIG. 2, made up of an clutch outer 71, a cylindrical tube 72, and clutch rollers 73. The clutch outer 71 is formed integrally with the carrier 65 of the planetary gear train 6. The tube 72 is designed as a clutch inner disposed within the clutch outer 71. The clutch rollers 73 are disposed along with roller springs (not shown) within wedge-shaped cam chambers formed in an inner periphery of the clutch outer 71 and work to transmit the torque from the clutch outer 71 that is a driving clutch rotor to the tube 72 that is a driven clutch follower.

The clutch outer 71 is installed on the head of the output shaft 20 of the motor 2 through a bearing and of a cup-shape which has a chamber opening frontward and a bottom serving as the carrier 65. The clutch outer 71 has a thrust washer (not shown) installed on a surface thereof which faces a rear end of the output shaft 3 in alignment therewith. An air gap is formed between a rear end of the clutch outer 71 and a front end of the output shaft 20 of the motor 2 to block the transmission of a thrust load therebetween.

The tube 72 has a bearing 72a protruding frontward. The bearing 72a is retained rotatably by the front end of the center case 12 through a ball bearing 74. The bearing 72a works as an inner race of the ball bearing 74.

The one-way clutch 7 also includes a washer 75 retained by a cover 76 firmly on the front end of the clutch outer 71 to hold the clutch rollers 73 within the clutch outer 71.

The output shaft 3 is disposed at a rear end thereof within the tube 72 in alignment with the output shaft 20 of the motor 2. The output shaft 3 is retained by the bearing 72a of the tube 72 to be movable in an axial direction of the starter 1. The output shaft 3 has formed on a rear end portion thereof an external helical spline 3a meshing with the internal helical spline 72c formed on an inner wall of the tube 72. The helical spline 72c extends from a rear end surface of the tube 72 to the bearing 72a. Specifically, the bearing 72a has no helical spline formed on a front end area of an inner wall thereof, so that the front end of the helical spline 72c servers as a stopper to stop further travel of the output shaft 3 when moved toward the engine (i.e., the left in the drawing), and the external helical spline 3a hits the rear end of the bearing 72a. Another type of stopper may alternatively be provided at another location. The output shaft 3 is retained at the front end thereof rotatably and movably by the front frame 11 through a bearing.

Disposed between the partition plate 13 and the planetary gear train 6 is a thrust washer 13a which extends radially of the starter 1 in abutment with the front end surface of the partition plate 13. The thrust washer 13a may be so formed as to extend further in a radial direction and nipped between the partition plate 13 and the outer cylindrical shell 66. The thrust washer 13a is made of a wear resistant circular disc and works to receive and bear the backward thrust transmitted from the output shaft 3 to the support pins 64 of the planetary gear train 6 when the output shaft 3 is moved backward by the shift lever 8 and hits the bottom of the clutch outer 71. This causes the friction between the support pins 64 and the thrust washer 13a to work to consume or absorb the energy of inertia rotation of the output shaft 3, thereby stopping the rotation of the output shaft 3 immediately.

The pinion gear 4 is jointed to the head of the output shaft 3 (i.e., a portion of the output shaft 3 projecting from the front frame 11) in a spline fashion to be rotatable in unison with the output shaft 3 and movable relative to the output shaft 3. The pinion gear 4 is also urged frontward (i.e., the left in FIG. 1) by a pinion spring disposed between the pinion gear 4 and the output shaft 3 into abutment with a collar installed on the tip of the output shaft 3.

The center case 12 isolates the magnet switch 5 physically from the one-way clutch 7 and the planetary gear train 6. The magnet switch 5 includes a coil excited upon closing of a starter switch (not shown) of the vehicle, a plunger slidable within the coil, and a return spring. The head of the plunger project into the front frame 11. When the coil is energized by the starter switch, it will cause the plunger to be attracted frontward (i.e., the rightward, as viewed in FIG. 1) against a spring pressure of the return spring to advance the output shaft 3 through the shift lever 8. When the coil is deenergized, it will cause the plunger to be moved backward by the return spring to return the output shaft 3 through the shift lever 8. The structure of the magnet switch 5 is of a typical one, and explanation thereof in detail will be omitted here.

The shift lever 8 is supported by a lever holder to be swingable. The lever holder is secured to the center case 12. The shift lever 8 has an upper portion, as viewed in FIG. 1, joined to a hook retained by the plunger of the magnet switch 5 and a lower portion nipped between a pair of washers fitted on the output shaft 3, thereby transferring the movement of the plunger to the output shaft 3.

In FIG. 1, an upper side above a longitudinal center line of the output shaft 3 illustrates for the case where the magnet switch 5 is deenegized, while a lower side illustrates for the case where the magnet switch 5 is energized.

In operation of the starter 1, when the starter switch is closed to energized the coil of the magnet switch 5, it will cause the plunger to be attracted backward to advance the output shaft 5 away from the motor 2 through the shift lever 8.

When the pinion gear 4 hits the ring gear 9 without meshing with the ring gear 9, it will cause only the output shaft 3 to advance further, while compressing the pinion spring, so that the pinion gear 4 rotates and slides backward on the output shaft 3. When the pinion gear 4 rotates following the advancement of the output shaft 3 until it is allowed to mesh with the ring gear 9, it is urged or advanced by the reactive pressure produced by the pinion spring into mesh with the ring gear 9. The magnet switch 5 then moves a movable contact into contact with fixed contacts thereof to turn on the motor 2 to produce torque. Upon completion of the meshing of the pinion gear 4 with the ring gear 9, the torque is transmitted from the pinion gear 4 to the ring gear 9 to crank the engine.

After the start-up of the engine, the starter switch is opened to deenergize the coil of the magnet switch 5. This causes the plunger to be attracted frontward by the return spring. The movable contact of the magnet switch 5 are then moved out of contact with the fixed contacts to cut the supply of power to the motor 2. Additionally, the backward movement of the plunger causes the output shaft 3 to be moved by the shift lever 8 toward the motor 2, so that the rear end of the output shaft 3 hits on the clutch outer 71 and stops.

The structure of the starter 1 features use of the outer cylindrical shell 66 fitted on the planetary gear train 6. The outer cylindrical shell 66 will be described with reference to FIGS. 2, 3, and 4 below. FIG. 2 is an enlarged perspective view which shows the outer cylindrical shell 66.

The outer cylindrical shell 66 and the internal gear 62 serve as a torque impact absorber to absorb an excess of torque exerted on the internal gear 62 through the output shaft 3 and the one-way clutch 7.

The outer cylindrical shell 66 is, as can be seen from FIGS. 3 and 5, made up of a cylindrical main body 661, an annular inner flange 662, an annular extension 663, and protrusions or claws 664. The main body 661 is, as illustrated in FIG. 2, fitted on the outer circumference of the internal gear 62 of the planetary gear train 6. The inner flange 662 extends inwardly from a rear end of the main body 661. The annular extension 663 extends from a front end of the main body 661 in an axial direction of the outer cylindrical shell 66. The claws 664 protrude from a front end of the annular extension 663 and work as rotation stoppers or a lock mechanism to secure the outer cylindrical shell 66 to the center case 12 firmly. The surface of the outer cylindrical shell 66 is subjected to thermal treatment such as carburizing and hardened. The number of the claws 664 is six in this embodiment, but selected preferably from within a range of three (3) to over ten (10) in terms of sharing of torque acting on the outer cylindrical shell 66 and ease of machining.

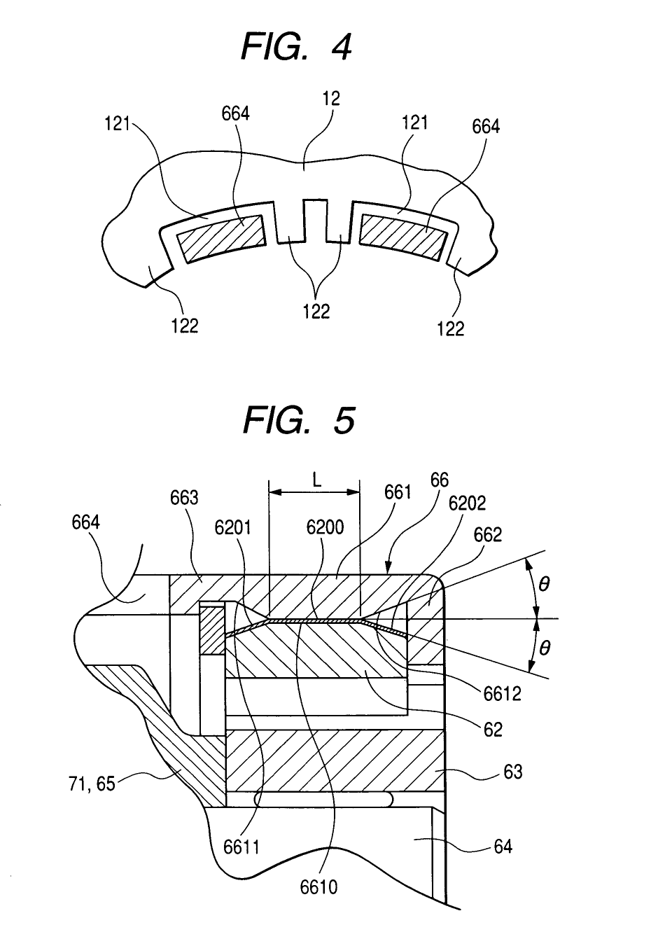

The main body 661 is placed in frictional engagement of the inner wall thereof with the outer wall of the internal gear 62. A selected degree of lubricity is provided between the inner wall of the main body 661 and the outer wall of the internal gear 62. The inner flange 662 is placed in abutment with the rear end surface of the internal gear 62 without reaching the bottom 621 of the internal gear 62. The inner flange 662 is also in abutment of the rear end surface thereof with the front end surface of the partition plate 13. The annular extension 663 has formed in an inner wall thereof an annular groove 665 in which a circlip 666 is, as illustrated in FIG. 2, is fitted to hold the internal gear 62 from uncoupling from the outer cylindrical shell 66 frontward. The claws 664 are arrayed on the annular extension 663 at equiangular intervals in a circumferential direction thereof and inserted, as clearly illustrated in FIG. 4, into lock grooves 121, respectively, which are formed in the inner wall of the center case 12. Specifically, the claws 664 serve as rotation stoppers to stop the outer cylindrical shell 66 from rotating relative to the center case 12. Formed between adjacent two of the lock grooves 121 is, as clearly shown in FIG. 4, a pair of teeth 122 which defines the circumferential width of the lock grooves 121. The lock grooves 121 are identical in number with the claws 664 and arrayed at equiangular intervals in the circumferential direction of the center case 12. The front end of the annular extension 663 is placed in abutment with the rear ends of the teeth 122. Alternatively, the front ends of the claws 664 may be in abutment with ends of the lock grooves 121. This causes the outer cylindrical shell 66 to be held in constant engagement with the center case 12 by the partition plate 13 urged frontward by fastening or tightening of the through-bolts 16.

Referring back to FIG. 2, the planet gears 63 and the support pins 64 are located to have portions protruding backward (i.e., the right direction as viewed in the drawing) from the internal gear 62 to a degree substantially smaller than the thickness of the inner flange 662 of the outer cylindrical shell 66. Specifically, the protruding portions of the planet gears 63 and the support pins 64 are in abutment with the partition plate 13 through the washer 13a. This minimizes elastic deformation of the planet gears 63 to reduce the loss of transmission of torque or mechanical noises, thus improving the impact resistance of the planetary gear train 6. The washer 13a may be omitted. In this case, lengths of the protruding portions are preferably identical with the thickness of the inner flange 662 so that they are placed in direct abutment with the partition plate 13a.

The outer cylindrical shell 66, as described above, has the six claws 664 serving as the rotation stoppers. It is advisable that the number of the claws 664 be greater than or equal to that of the planet gears 63, and the claws 664 be arrayed at equiangular intervals away from each other in order to minimize radial bending of the outer cylindrical shell 66.

FIG. 5 shows a modification of the outer cylindrical shell 66 and the internal gear 62.

The inner peripheral wall of the main body 661 of the outer cylindrical shell 66 is made up of three parts: a central contact portion 6610 and fitting guide portions 6611 and 6612 extending in opposite directions from the contact portion 6610. Similarly, the outer peripheral wall of the internal gear 62 is made up of three parts: a central contact portion 6200 and fitting guide portions 6201 and 6202 extending in opposite directions from the contact portion 6200. The contact portions 6610 and 6200 are in frictional contact with each other. Each of the fitting guide portions 6201 and 6202 of the internal gear 62 is tapered to have an outer diameter decreasing with distance from the contact portion 6200. Each of the fitting guide portions 6611 and 6612 of the outer cylindrical shell 66 is tapered to have an inner diameter increasing with distance from the contact portion 6610.

Each of the fitting guide portions 6611, 6612, 6210, and 6202 has a length of 1 mm or more in the axial direction of the outer cylindrical shell 66 or the internal gear 62. A taper angle θ which a line extending along the surface of the contact portion 6610 of the outer cylindrical shell 66 makes with a line extending along the surface of the fitting guide portion 6612 is selected to lie within a range of 15° to 30°. Similarly, a taper angle θ which a line extending along the surface of the contact portion 6200 of the internal gear 62 makes with a line extending along the surface of the fitting guide portion 6212 is selected to lie within a range of 15° to 30°. The same applies to tapered angles of the fitting guide portions 6611 and 6201.

At least the inner peripheral wall of the outer cylindrical shell 66 and at least the outer peripheral wall of the internal gear 62 are thermally treated, e.g., carburized. After such treatment, either of the inner peripheral wall of the outer cylindrical shell 66 or the outer peripheral wall of the internal gear 62 is coated with a solid lubricating layer. The solid lubricating layer may be formed by grinding a selected one of the carburized inner peripheral wall of the outer cylindrical shell 66 and the carburized outer peripheral wall of the internal gear 62, subjecting it to chemical conversion such as bonderizing, and then turning it in a tumbler in which molybdenum disulfide is put, spraying molybdenum disulfide to it, or immersing it in a tub filled with molybdenum disulfide. The organic molybdenum may alternatively be used. The thickness of the solid lubricating layer is preferably 10 μm to 30 μm. The minimum thickness of the outer cylindrical shell 66 and the internal gear 62 in the radius direction is 2.5 mm. A slip torque which acts on the internal gears 62 and induces it to skid relative to the outer cylindrical shell 66 is 150 N·m to 200 N·m. This minimizes scratches on the solid lubricating layer or the surfaces of the outer cylindrical shell 66 and the internal gear 62 which will be in friction when the outer cylindrical shell 66 is fitted on the internal gear 62, thereby ensuring the lubricity between the inner wall of the outer cylindrical shell 66 and the internal gear 62.

Specifically, the tapered fitting guide portions 6611, 6612, 6201, and 6202 serve to minimize the possibility of damage to the outer cylindrical shell 66 and the internal gear 62 when they are joined together. This eliminates the need for holding grease or a lubricant supplying mechanism which are required in the conventional structure The length of each of the fitting guide portions 6611, 6612, 6210, and 6202 may be changed as a function of the degree of slip torque of the internal gear 62 without changing the overall axial length of the outer cylindrical shell 66 and the internal gear 62.

When the torque which is greater than the friction between the outer peripheral surface of the internal gear 62 and the inner peripheral surface of the main body 661 of the outer cylindrical shell 66 is applied to the internal gear 62, it causes the internal gear 62 to rotate relative to the outer cylindrical shell 66, thereby absorbing such an undesirable excessive torque.

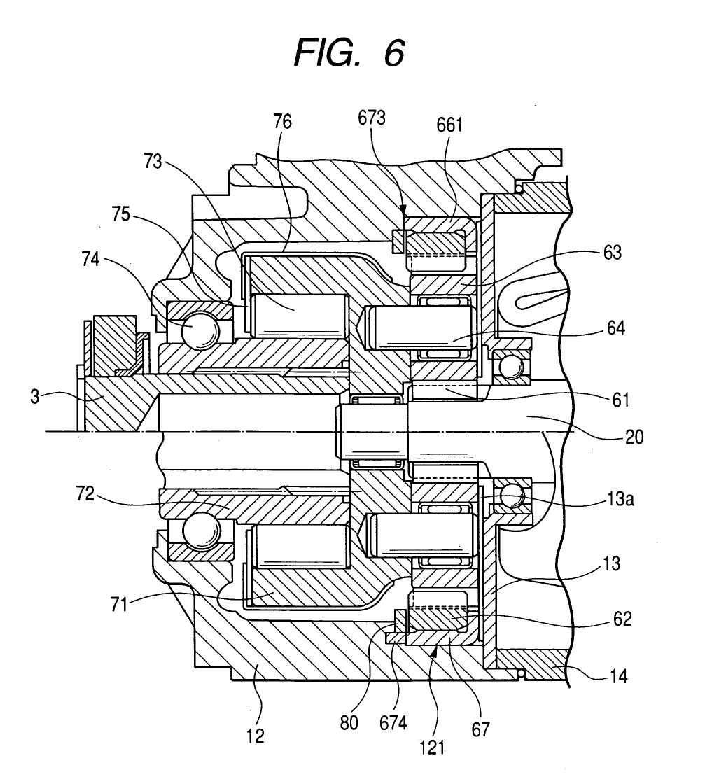

FIG. 6 shows the starter 1 according to the second embodiment of the invention.

The outer cylindrical shell 66 of the first embodiment, as described above, has the annular groove 665 in which the circlip 666 is fitted. The stress usually concentrates on such an area. Therefore, when the slip torque on the internal gear 62 is greater than, for example, 200N·m, it may cause damage to the groove 665. In order to avoid this problem, the starter 1 of the second embodiment has the outer cylindrical shell 67 of the structure, as illustrated in FIG. 6.

The outer cylindrical shell 67 includes an annular extension 673 protruding from the main body 661 and claws 674 protruding from the annular extension 673. The claws 674 work as rotation stoppers and are arrayed at regular angular intervals in the circumferential direction of the annular extension 673. The center case 12 has formed in the inner wall thereof grooves 121 which are arrayed in the circumferential direction at the same angular intervals as those of the claws 674. The claws 674 of the outer cylindrical shell 67 are fitted in the grooves 121 of the center case 12, respectively. The outer cylindrical shell 67 does not have the groove 655, as illustrated in FIG. 2. The length of claws 674 is smaller than that of the claws 664 in the first embodiment in the axial direction of the outer cylindrical shell 67, thereby increasing the mechanical strength more than that of the claws 664.

The annular extension 673 is urged by the thrust washer 13a and the partition plate 13 into constant abutment with the center case 12 and fixed firmly by fastening of the through-bolts 16. A washer 80 is disposed between the center case 12 and the internal gear 62 to hold the internal gear 62 from uncoupling from the outer cylindrical shell 67. An air gap is formed between the washer 80 and the internal gear 62 to assure sliding motion of the internal gear 62. The washer 80 may have formed on an outer periphery protrusions which are fitted in grooves formed in the center case 12 to hold the washer 80 from rotating.

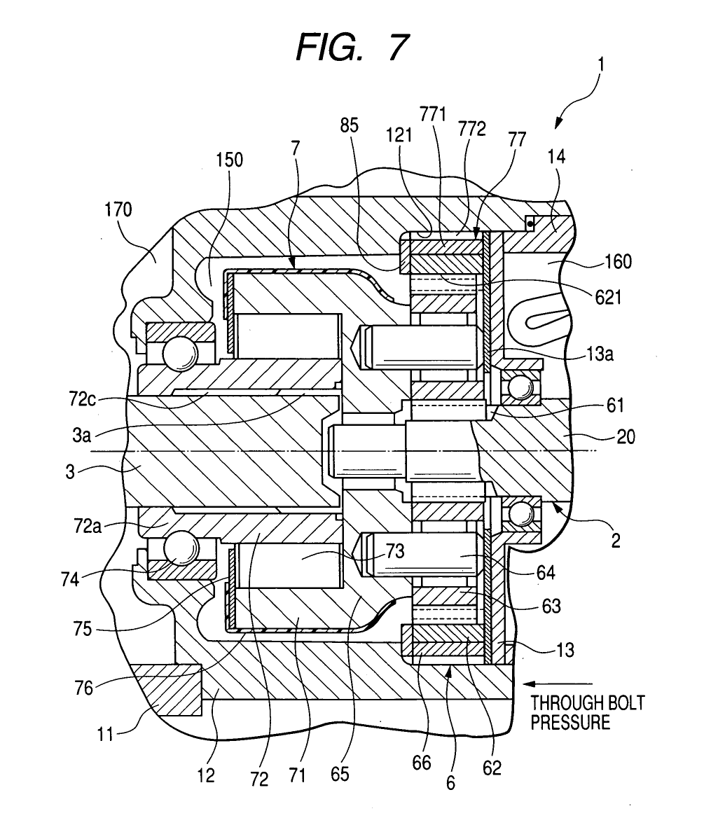

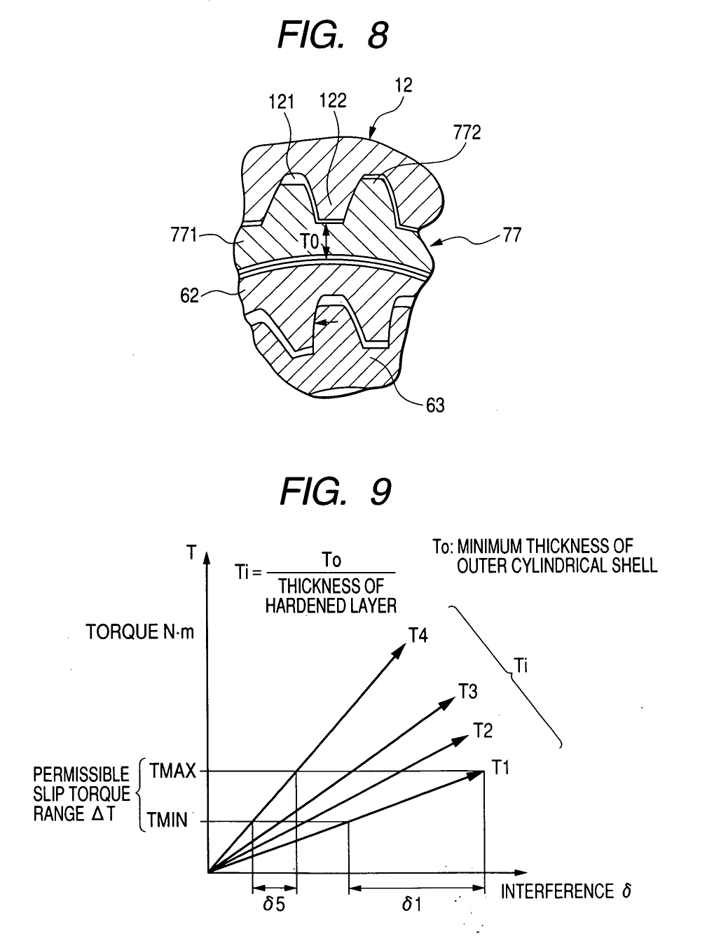

FIGS. 7 and 8 show the outer cylindrical shell 77 according to the third embodiment of the invention.

The outer cylindrical shell 77 is made up of a hollow cylindrical main body 771 with open ends and lock protrusions 772. The main body 771 is fitted on the outer circumference of the internal gear 62 of the planetary gear train 6. The lock protrusions 772 are ridges which are formed on the outer peripheral surface of the main body 771 and extend parallel to an axial direction of the outer cylindrical shell 77. The lock protrusions 772 are arrayed at a given angular interval away from each other in a circumferential direction of the outer cylindrical shell 77. The lock protrusions 772 may alternatively be arrayed in a spiral fashion on the outer peripheral surface of the main body 771. The main body 771 has an inner surface placed in frictional engagement with the outer peripheral surface of the internal gear 62.

Each of the lock protrusions 772 is, as clearly illustrated in FIG. 8, of a gear tooth shape and fitted in one of grooves 121 formed in the inner peripheral wall of a rear end portion of the center case 12. The number of the grooves 121 is identical with that of the lock protrusions 772. Each of the lock protrusions 772 may alternatively have another shape.

The outer cylindrical shell 77 also includes an annular washer 85 placed in abutment with the front end of the outer cylindrical shell 77. The washer 85 has protrusions, like the ones 772, formed on an outer periphery thereof which are nipped firmly between front ends, as viewed in the drawing, of the grooves 121 and the front end surface of the main body 771 of the outer cylindrical shell 77. The washer 85 works as a stopper to hold the internal gear 62 from moving out of the outer cylindrical shell 77 in the frontward direction. The washer 85 preferably has an inner periphery located outward of the tops of teeth of the planet gears 63 in the radial direction of the planetary gear train 6.

The outer cylindrical shell 77 is placed in abutment of the rear end surface thereof with the front end surface of the thrust washer 13a. The washer 85, the outer cylindrical shell 6, the thrust washer 13a, and the partition plate 13 are urged in the axial direction of the starter 1 and joined together by joining the yoke 14 to the center case 12 firmly using the through-bolts 16. The thrust washer 13a is, therefore, placed in direct contact with the rear end surface of the internal gear 62 and works to block direct relative rotation between the internal gear 62 and the partition plate 13, thus minimizing the wear of the partition plate 13. The thrust washer 13a working to bear the thrust load which arises from backward movement of the output shaft and is transmitted through the support pins 64 of the planetary gear train 6 is retained in the center case 12 firmly by fastening pressure exerted on the through-bolts 16. This structure facilitates ease of machining the grooves 121 in the inner wall of the center case 12 for installation of the washer 85, the outer cylindrical shell 77, and the thrust washer 13a. The washer 85, as described above, has formed on the circumference thereof the protrusions, like the ones 772 of the outer cylindrical shell 77, which are fitted in the grooves 121 to secure the washer 85 firmly to the center case 12. Similarly, the thrust washer 13a and the partition plate 13 have protrusions, like the ones 772 of the outer cylindrical shell 77, which are also fitted in the grooves 121 to hold them from rotating.

Essential features of this embodiment will be described below in detail.

The Number of Lock Protrusions 772

The number of the lock protrusions 772 formed on the outer peripheral surface of the outer cylindrical shell 66 is at least identical with that of the planet gears 63 of the planetary gear train 6. In other words, the number of the lock protrusions 772 is one time or more that of the planet gears 63. In this embodiment, the number of the planet gears 63 is three (3). The pitch of the lock protrusions 772 is more preferably 0.5 to 2.0 times the pitch of teeth of the internal gear 62. This ensures the stability of transmission of torque from the teeth of the internal gear 62 to the lock protrusions 772 of the outer cylindrical shell 77 located radially of the internal gear 62 when a large-scale torque is applied to the internal gear 62 from the planet gears 63, thus minimizing a change in circularity of the outer cylindrical shell 66 arising from the deformation thereof. This decreases partial wear of the inner peripheral surface of the outer cylindrical shell 66 and the outer peripheral surface of the internal gear 62 or an undesirable change in the slip torque of the internal gear 62 which is caused by a difference between pressures acting on contacts therebetween and also permits minimum radial thicknesses of the outer cylindrical shell 66 and the internal gear 62 to be decreased, thereby resulting in a lightweight structure of the planetary gear train 6 or the center case 12.

Thickness of Outer Cylindrical Shell 77

The partial wear of the inner peripheral surface of the outer cylindrical shell 66 and the outer peripheral surface of the internal gear 62 or the undesirable change in the slip torque of the internal gear 62 are, as described above, decreased by use of a lot of the lock protrusions 772 to retain the outer cylindrical shell 77 firmly, which permits the radial thickness of the outer cylindrical shell 77 to be decreased greatly. The radial thickness of the outer cylindrical shell 77, as referred to herein, corresponds to the difference between the outer and inner diameters of portions thereof not having the lock protrusions 772 and is, in this embodiment, the bottom thickness To, as indicated in FIG. 8, between adjacent two of the lock protrusions 772.

The decreasing of the thickness of the outer cylindrical shell 77 permits the tolerance of the inner diameter of the outer cylindrical shell 77 to be decreased in design thereof, thus facilitating ease of production and installation of the outer cylindrical shell 66. This will be discussed below in detail.

The slip torque which exceeds the friction on areas of contact between the inner peripheral surface of the outer cylindrical shell 77 and the outer peripheral surface of the internal gear 63 and induces the slippage of the internal gear 62 relative to the outer cylindrical shell 66 is proportional to the value given by contact pressure×frictional areas of contact×radius where the contact pressure is the pressure acting on the frictional areas of contact between the inner peripheral surface of the outer cylindrical shell 77 and the outer peripheral surface of the internal gear 63, and the radius is the distance between the center axis of the outer cylindrical shell 77 and the frictional areas of contact between the inner peripheral surface of the outer cylindrical shell 77 and the outer peripheral surface of the internal gear 63. In other words, the slip torque is proportional to the contact pressure which is produced as a function of an interference between the inner peripheral surface of the outer cylindrical shell 77 and the outer peripheral surface of the internal gear 62. The outer cylindrical shell 77 is press-fit on the outer peripheral surface of the internal gear 62. The decreasing of the thickness of the outer peripheral shell 77 will result in a decrease in rigidity thereof, thus facilitating ease of elastic deformation thereof in the radial direction. This, thus, allows an permissible range (i.e., the tolerance) of the interference which is required to produce the contact pressure within a desired range, to be increased. The permissible range of the interference may be considered to be equivalent to the tolerance of the diameter of the inner peripheral surface of the outer cylindrical shell 77. A permissible range of the contact pressure corresponds to a permissible range of the slip torque since the slip torque is, as described above, proportional to contact pressure×frictional areas of contact×radius (distance between the center axis and the frictional areas of contact). The permissible range of the slip torque is predetermined depending upon the type of the starter 1. Consequently, the permissible range of the interference may be increased within the permissible range of the slip torque as the minimum thickness (i.e., the bottom thickness To) of the outer cylindrical shell 77 is decreased. This will be discussed below in detail using an interference characteristic view of FIG. 9.

In FIG. 9, the vertical axis indicates the slip torque T. The horizontal axis indicates the interference between the inner peripheral surface of the outer cylindrical shell 77 and the outer peripheral surface of the internal gear 62. T1, T2, T3, and T4 indicate values (which will also be referred to as a thickness ratio Ti below) derived by dividing the minimum thickness To of the outer cylindrical shell 77 by the thickness of a thermally hardened layer of the outer cylindrical shell 77 and used as a basis for expressing the minimum thickness To of the outer cylindrical shell 77 because of convenience. The outer cylindrical shell 77 is heat-treated, e.g., case-hardened to have the thermally hardened layer. T1 is 2.4. T2 is 3.2. T3 is 4.8. T4 is 5.6. δ1 denotes a permissible range of the interference between the outer cylindrical shell 77 and the internal gear 62 when the thickness ratio Ti is T1=2.4, and the slip torque is within the permissible range. δ5 denotes a permissible range of the interference between the outer cylindrical shell 77 and the internal gear 62 when the thickness ratio Ti is T4=5.6, and the slip torque is within the permissible range.

The internal gear 62 is, as described above, press-fit in the outer cylindrical shell 77. The interference between the internal gear 62 and the outer cylindrical shell 77 is preferably within the range δ1 in terms of ease of machining and assembling. The permissible range of the slip torque, as expressed by ΔT in FIG. 9, which causes the internal gear 62 to slide relative to the outer cylindrical shell 77 is usually predetermined depending upon the type of the starter 1. The minimum thickness To of the outer cylindrical shell 77 is the sum of thicknesses of outer and inner areas of the thermally hardened layer defining the outer and inner peripheral surfaces and the thickness of a non heat-treated body of the outer cylindrical shell 77 other than the thermally hardened layer. The minimum thickness of the non heat-treated body of the outer cylindrical shell 77 is required to be greater than or equal to that of the thermally hardened layers. The thermally hardened layer is required to have a thickness greater than a preselected minimum value. For instance, when the thickness of the thermally hardened layer is set to 0.8 mm so as to achieve a slip torque of 150N·m, the minimum thickness To is 2.4 mm (=0.8×3) to 3.2 mm. The tolerance of the interference is 60 μm to 70 μm.

From the above conditions, the inventors of this application have found that selection of the thickness of the non heat-treated body of the outer cylindrical shell 77 to be one (1) to two (2) times that of the thermally hardened layer enables the torque impact absorbing mechanism equipped with the outer cylindrical shell 77 working to absorb an excessive torque acting on the internal gear 62 within the permissible slip torque range ΔT to be produced without need for advanced manufacturing requirements.

It is, therefore, found that the permissible range of interference between the outer cylindrical shell 77 and the internal gear 62 of the planetary gear train 6 may be increased greatly by increasing the lock protrusions 772 of the outer cylindrical shell 77 and decreasing the minimum thickness To thereof, thereby facilitating ease of press-fitting of the outer cylindrical shell 77 on the internal gear 62.

For instance, comparison between the thickness ratios T1 and T4 in FIG. 9 shows that the former case where the thickness of the outer cylindrical shell 77 is smaller achieves a wider permissible range of the interference (i.e., δ5). Conversely, increasing of the minimum thickness To of the outer cylindrical shell 77 will result in a decrease in the permissible range of the interference between the outer cylindrical shell 77 and the internal gear 62, thus leading to a difficulty in machining and assembling them. The fact that the permissible range of the interference between the outer cylindrical shell 77 and the internal gear 62 is increased means that the tolerance in grinding the surface of the outer cylindrical shell 77 after case-hardened, as will be described later, is allowed to be increased and that when a solid lubricating layer is, like the first embodiment, formed on the inner peripheral surface of the outer cylindrical shell 77, the tolerance in grinding the inner peripheral surface before coated with the solid lubricating layer is allowed to be increased.

Surface Treatment of Outer Cylindrical Shell 77

The inner peripheral surface of the outer cylindrical shell 77 is, as described above, placed in friction with the outer peripheral surface of the internal gear 62 and thus required to have wear-resistant properties. The best method of providing the wear resistance to the outer cylindrical shell 77 is caburizing in terms of the productivity. Similarly, the outer peripheral surface of the outer cylindrical shell 77 is preferably to have a thermally hardened layer for the purpose of minimizing the wear thereof. It is, however, well known that the formation of the thermally hardened layer on the outer cylindrical shell 77 through the carburizing will result in decreased toughness of the outer cylindrical shell 77. Ensuring a desired degree of such toughness requires the outer cylindrical shell 77 to have a non heat-hardened inner layer of a thickness which is at least greater than or equal to that of the thermally hardened layer formed on the outer surface of the outer cylindrical shell 77. This means that when the thickness of the thermally hardened layer is defined as one (1), the minimum thickness To of the outer cylindrical shell 77 is needed to be at least three (3). The minimum thickness To of the outer cylindrical layer 77 is preferably three to five times, more preferably three to four times that of the thermally hardened layer. This allows the outer cylindrical shell 77 to have a thickness suitable for practical use, which results in an increase in tolerance in machining the outer cylindrical shell 77 (i.e., the above described permissible range of the interference), ease of fitting the outer cylindrical shell 77 on the internal gear 62, and a decrease in size of the one-way clutch 7.

The outer cylindrical shell 77 is preferably made of chromium molybdenum steel (SCM415) suitable for the carburizing. Typically, after carburized, the surface of the outer cylindrical shell 77 is ground. The tolerance of such grinding may be increased within the permissible slip torque range A Tby formation of a lot of the lock protrusions 772 on the outer cylindrical shells 77.

In this embodiment, in order to achieve a slip torque of 150N·m on the internal gear 62, the carburized case depth of the outer cylindrical shell 77 is 0.8 mm. The minimum thickness To of the outer cylindrical shell 77 is within 2.4 mm to 4.2 mm. These conditions may apply to the internal gear 62.

Coating of Solid Lubricating Layer

The inner peripheral surface of the outer cylindrical shell 77 is, like the first embodiment, coated with a solid lubricating layer after being carburized and ground, as described above. The solid lubricating layer may be formed by subjecting the inner peripheral surface of the outer cylindrical shell 77 to a lubricant-retaining surface treatment such as bonderizing and then coating it with molybdenum disulfide. Such coating may be achieved by turning the outer cylindrical shell 77 in a tumbler in which molybdenum disulfide is put, spraying molybdenum disulfide to it, or immersing it in a tub filled with molybdenum disulfide. The thickness of the solid lubricating layer is preferably 10 μm to 30 μm. The outer peripheral surface of the internal gear 62 may be coated with such a solid lubricating layer.

The degree of press-fit between the outer cylindrical shell 77 and the internal gear 62 depends upon a total of a tolerance of an amount by which the surface of the outer cylindrical shell 77 is, as described above, ground, a tolerance in the lubricating-retaining surface treatment, and a tolerance of thickness of the solid lubricating layer. In a case where the outer and inner peripheral surfaces of the outer cylindrical shell 77 are heat-treated, the grinding tolerance will be twice in total. The sum of these tolerances is equivalent to the above described permissible range of the interference between the outer cylindrical shell 77 and the internal gear 62. The increasing of such a permissible range is, as described above, achieved by the formation of a lot of the lock protrusions 772 on the outer cylindrical shell 77. This is a feature of the structure of the starter 1 of this embodiment.

Fitting of Outer Cylindrical Shell 77

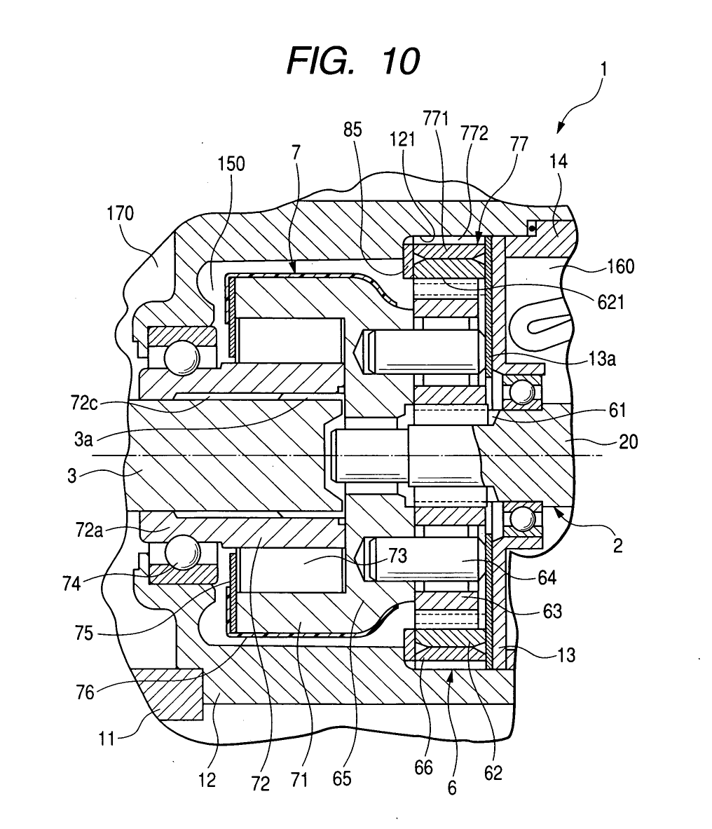

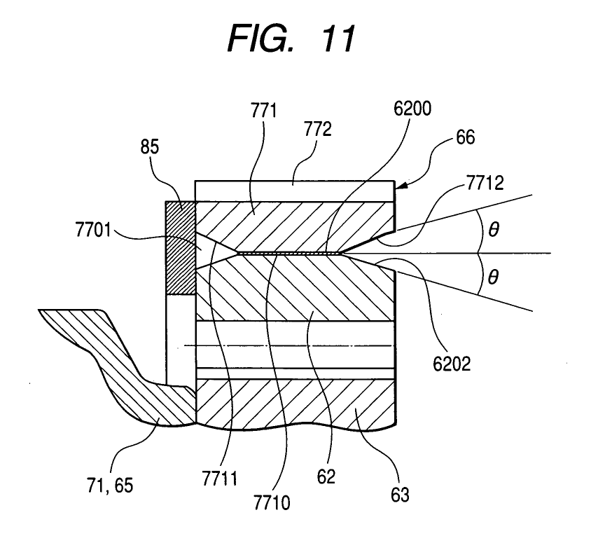

When the outer cylindrical shell 77 is fitted on the internal gear 62, an inner peripheral corner of the outer cylindrical shell 77 may hit an outer peripheral corner of the internal gear 62, thus causing damage to the above described solid lubricating layer formed on either of both of the inner peripheral surface of the outer cylindrical shell 77 and the outer peripheral surface of the internal gear 62. Such damage increase ease of separation of the solid lubricating layer from the damaged area, thus increasing the possibility of seizing of the outer cylindrical shell 77 or the internal gear 62. In order to avoid this problem, the outer cylindrical shell 77 and the internal gear 62 may be designed to have structures as illustrated in FIGS. 10 and 11.

The outer cylindrical shell 77 includes, like the third embodiment, the hollow cylindrical main body 771. The inner peripheral wall of the main body 771 of the outer cylindrical shell 77 is made up of three parts: a central contact portion 7710 and fitting guide portions 7711 and 7712 extending in opposite directions from the contact portion 7710. Similarly, the outer peripheral wall of the internal gear 62 is made up of three parts: a central contact portion 6200 and fitting guide portions 6201 and 6202 extending in opposite directions from the contact portion 6200. The contact portions 7710 and 6200 are in frictional contact with each other. Each of the fitting guide portions 6201 and 6202 of the internal gear 62 is tapered to have an outer diameter decreasing with distance from the contact portion 6200. Each of the fitting guide portions 7711 and 7712 of the outer cylindrical shell 77 is tapered to have an inner diameter increasing with distance from the contact portion 7710.

Each of the fitting guide portions 7711, 7712, 6210, and 6202 has a length of 1 mm or more in the axial direction of the outer cylindrical shell 77 or the internal gear 62. The taper angle θ which a line extending along the surface of the contact portion 7710 of the outer cylindrical shell 7 makes with a line extending along the surface of the fitting guide portion 7712 is selected to lie within a range of 15° to 30°. Similarly, the taper angle θ which a line extending along the surface of the contact portion 6200 of the internal gear 62 makes with a line extending along the surface of the fitting guide portion 6212 is selected to lie within a range of 15° to 30°. The same applies to tapered angles of the fitting guide portions 7711 and 6201.

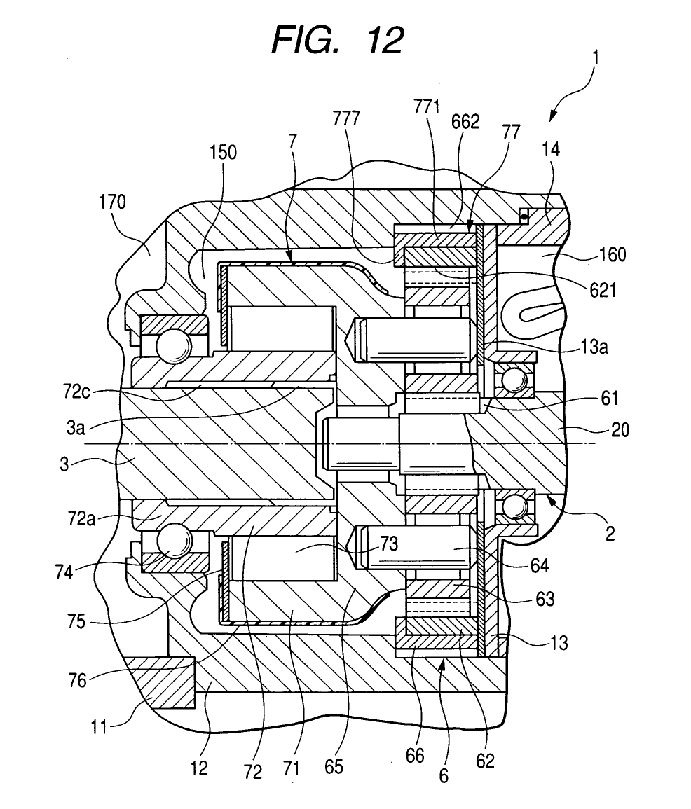

FIG. 12 shows the starter 1 according to the fifth embodiment of the invention which is a modification of the one, as illustrated in FIG. 7.

The outer cylindrical shell 77 includes an inner flange 773 extending inwardly from the front end of the main body 771. The inner flange 773 works as a stopper to hold the internal gear 62 from being dislodged out of the outer cylindrical shell 77.

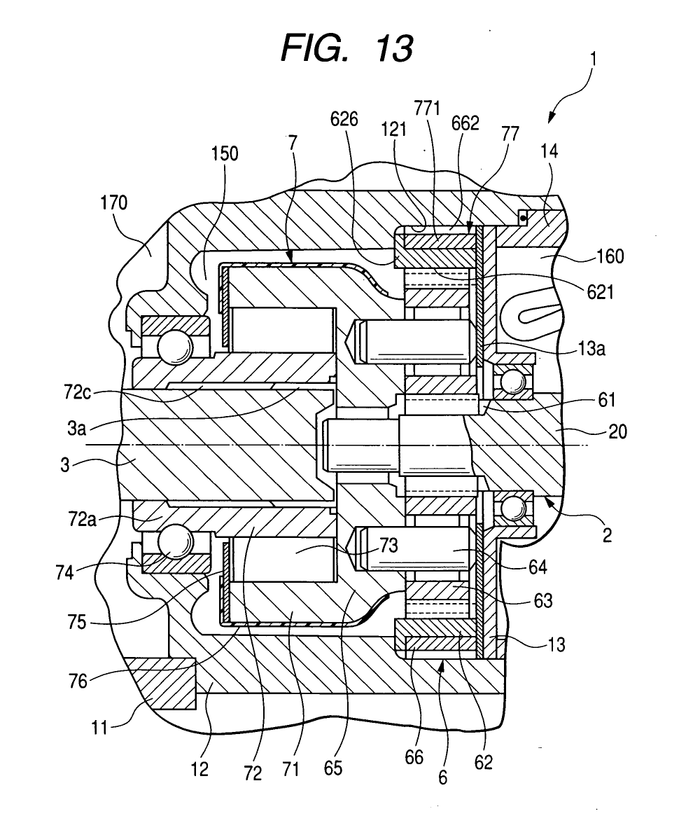

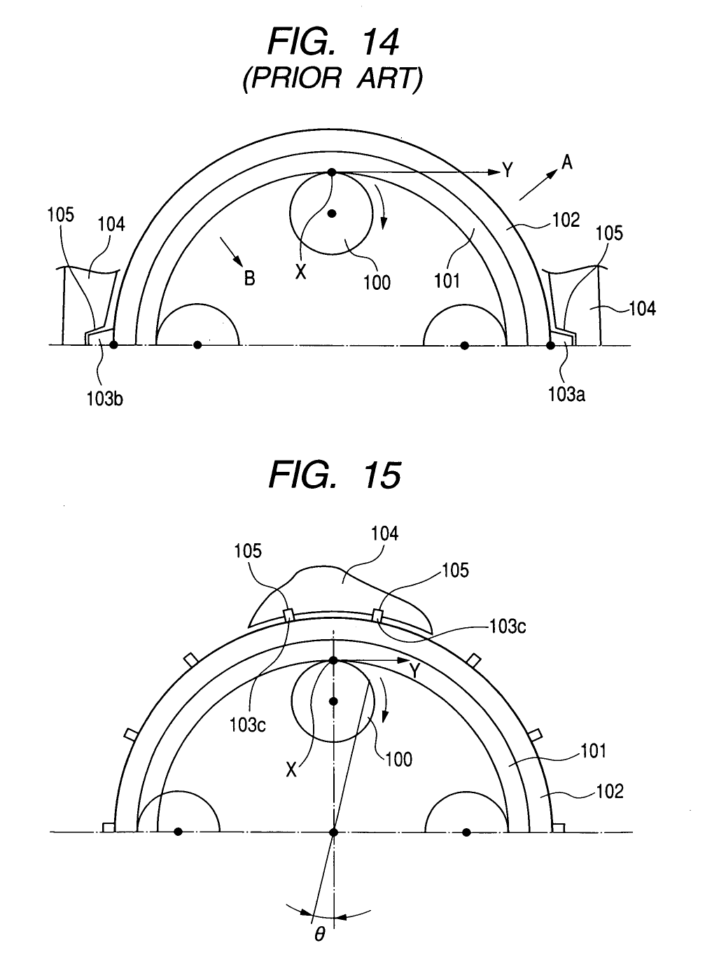

FIG. 13 shows the starter 1 according to the fifth embodiment of the invention which is a modification of the one, as illustrated in FIG. 7.

The internal gear 62 includes an annular outer flange 626 extending outward of the front end thereof. The outer flange 626 has protrusions which are fitted in the lock grooves 121 of the center case 12 and nipped between the front end of the outer cylindrical shell 77 and the ends of the lock grooves 121 to retain the internal gear 62 from moving in the axial direction thereof.

In the above embodiments, the locking mechanism to lock the outer cylindrical shells 66 or 77 may alternatively be designed to have protrusions formed on the inner wall of the center case 12 and grooves formed in the outer peripheral wall of the outer cylindrical shell 66 or 77 in which the protrusion are to be fitted in place of the grooves 121 and the lock protrusions 662 or 772.

While the present invention has been disclosed in terms of the preferred embodiments in order to facilitate better understanding thereof, it should be appreciated that the invention can be embodied in various ways without departing from the principle of the invention. Therefore, the invention should be understood to include all possible embodiments and modifications to the shown embodiments which can be embodied without departing from the principle of the invention as set forth in the appended claims.

What is claimed is:

1. A starter comprising:
a casing;
an electric motor disposed within said casing, the motor having an output shaft;
a one-way clutch disposed frontward of said motor within said casing;
a planetary gear train disposed between said motor and said one-way clutch within said casing, said planetary gear train working as a speed reducer to reduce a speed of rotation of the output shaft of said motor to transmit torque of the output shaft to said one-way clutch;
a starter output shaft retained in said casing rotatably for outputting the torque of the output shaft of said motor, as transmitted through said one-way clutch; and
an outer cylindrical member so fitted on an outer peripheral surface of an internal gear of said planetary gear train as to establish frictional engagement therewith when torque applied to the internal gear is less than a given value, said outer cylindrical member including a hollow cylindrical body and lock protrusions, the lock protrusions extending in an axial direction of said outer cylindrical member from a front end of the cylindrical body oriented toward said one-way clutch, the lock protrusions being arrayed at given angular intervals in a circumferential direction of the cylindrical body and fitted in grooves formed in an inner peripheral wall of the casing.

2. A starter as set forth in claim 1, wherein the number of the lock protrusions is greater than or equal to that of planet gears of said planetary gear train.

3. A starter as set forth in claim 1, wherein the cylindrical body of said outer cylindrical member includes a main body, an annular extension, an inner flange, and a stopper member, the annular extension extending in an axial direction of said outer cylindrical member from a front end of the main body oriented toward said one-way clutch, the inner flange extending inwardly from a rear end of the main body in abutment with a rear end surface of the internal gear, the stopper member being fitted on an inner peripheral wall of the annular extension to hold the internal gear from moving in the axial direction within the main body.

4. A starter as set forth in claim 1, wherein the cylindrical body of said outer cylindrical member includes an inner flange and a washer, the inner flange extending inwardly from a rear end of the cylindrical body in abutment with a rear end surface of the internal gear, the washer being in engagement with the inner peripheral wall of said casing to hold the internal gear from moving in the axial direction within the cylindrical body.

5. A starter as set forth in claim 4, wherein said casing includes a front case, a center case, and an end case in which said motor is disposed, and wherein said washer has a lock protrusion, the lock protrusions of the washer and said outer cylindrical member being urged into constant abutment with end walls of the grooves formed in the casing by fastening a through bolt to joint the end case to the center case firmly.

6. A starter as set forth in claim 3, wherein the inner flange has an inner edge located outside radially outward ends of planet gears of said planetary gear train, and wherein rear ends of the planet gears protrude rearward from the rear end surface of the internal gear and are located at least frontward of a rear end surface of the inner flange.

7. A starter as set forth in claim 4, wherein the inner flange has an inner edge located outside radially outward ends of planet gears of said planetary gear train, and wherein rear ends of the planet gears protrude rearward from the rear end surface of the internal gear and are located at least frontward of a rear end surface of the inner flange.

8. A starter as set forth in claim 1, wherein one of the cylindrical body of said outer cylindrical member and the internal gear includes a central contact surface and fitting guide surfaces continuing from the central contact surface in axial opposite directions of the one of the cylindrical body and the internal gear, the central contact surface being in frictional contact with other of the cylindrical body and the internal gear, the fitting guide surfaces being tapered to guide fitting of the internal gear into said outer cylindrical member.

9. A starter as set forth in claim 8, wherein the central contact surface and the fitting guide surfaces are coated with a solid lubricating layer.

10. A starter as set forth in claim 8, wherein a length of each of the fitting guide surfaces is so selected as to establish a slip torque which causes the internal gear to slide on said outer cylindrical member when the slip torque is applied to the internal gear.

11. A starter comprising:
a casing having fit-features;
an electric motor disposed within said casing, the motor having an output shaft;
a one-way clutch disposed frontward of said motor within said casing;
a planetary gear train disposed between said motor and said one-way clutch within said casing, said planetary gear train working as a speed reducer to reduce a speed of rotation of the output shaft of said motor to transmit torque of the output shaft to said one-way clutch;
a starter output shaft retained in said casing rotatably for outputting the torque of the output shaft of said motor, as transmitted through said one-way clutch; and
an outer cylindrical member so fitted on an outer peripheral surface of an internal gear of said planetary gear train as to establish frictional engagement therewith when torque applied to the internal gear is less than a given value, said outer cylindrical member including an outer peripheral surface which has mating fit-features establishing fits with the fit-features of said casing to achieve a joint between said outer cylindrical member and said casing, the mating fit-features being more in number than or equal to planet gears of said planetary gear train and arrayed at a given interval away from each other in a circumferential direction of the outer peripheral surface.

12. A starter as set forth in claim 11, wherein the interval between adjacent two of the mating fit-features is substantially identical with a pitch of teeth of the internal gear of said planetary gear train.

13. A starter as set forth in claim 11, wherein each of the mating fit-feature of said outer cylindrical member is made of a protrusion of a gear tooth shape.

14. A starter as set forth in claim 11, wherein said outer cylindrical member is made of an outer thermally hardened layer, an inner thermally hardened layer, and a non thermally hardened layer between the outer and inner thermally hardened layers, the outer and inner thermally hardened layers defining the outer peripheral surface and an inner peripheral surface of said outer cylindrical member, respectively, the non thermally hardened layer having a thickness which is one to two times that of each of the outer and inner thermally hardened layers.

15. A starter as set forth in claim 11, wherein said outer cylindrical member has an inner flange which extends inward from a front end thereof and works as a stopper to retain the internal gear from moving frontward in an axial direction of the internal gear.

16. A starter as set forth in claim 11, wherein the internal gear has an outer which extends outward from a front end thereof and works as a stopper to retain the internal gear from moving frontward in an axial direction of the internal gear.

17. A starter comprising:
a casing having fit-features;
an electric motor disposed within said casing, the motor having an output shaft;
a one-way clutch disposed frontward of said motor within said casing;
a planetary gear train disposed between said motor and said one-way clutch within said casing, said planetary gear train working as a speed reducer to reduce a speed of rotation of the output shaft of said motor to transmit torque of the output shaft to said one-way clutch;
a starter output shaft retained in said casing rotatably for outputting the torque of the output shaft of said motor, as transmitted through said one-way clutch; and
an outer cylindrical member so fitted on an outer peripheral surface of an internal gear of said planetary gear train as to establish frictional engagement therewith when torque applied to the internal gear is less than a given value, said outer cylindrical member including an outer peripheral surface which has mating fit-features establishing fits with the fit-features of said casing to achieve a joint between said outer cylindrical member and said casing,
wherein one of an inner peripheral wall of said outer cylindrical member and an outer peripheral wall of the internal gear includes a central contact surface and fitting guide surfaces continuing from the central contact surface in axial opposite directions of the one of said outer cylindrical member and the internal gear, the central contact surface being in frictional contact with other of said outer cylindrical member and the internal gear, the fitting guide surfaces being tapered to guide fitting of the internal gear into said outer cylindrical member, and wherein the central contact surface and the fitting guide surfaces are coated with a solid lubricating layer.

18. A starter as set forth in claim 17, wherein a length of each of the fitting guide surfaces is so selected as to establish a slip torque which causes the internal gear to slip on said outer cylindrical member when the slip torque is applied to the internal gear.

19. A starter comprising:
a casing having fit-features and an inner shoulder;
an electric motor disposed within said casing, the motor having an output shaft and a yoke, the yoke being joined at an end thereof to said casing by a through bolt;
a one-way clutch disposed frontward of said motor within said casing;
a planetary gear train disposed between said motor and said one-way clutch within said casing, said planetary gear train working as a speed reducer to reduce a speed of rotation of the output shaft of said motor to transmit torque of the output shaft to said one-way clutch;
a starter output shaft retained in said casing rotatably for outputting the torque of the output shaft of said motor, as transmitted through said one-way clutch;
an outer cylindrical member so fitted on an outer peripheral surface of an internal gear of said planetary gear train as to establish frictional engagement therewith when torque applied to the internal gear is less than a given value, said outer cylindrical member including an outer peripheral surface which has mating fit-features establishing fits with the fit-features of said casing to achieve a joint between said outer cylindrical member and said casing;
a first washer disposed between the inner shoulder of said casing and front ends of the internal gear of said planetary gear train and said outer cylindrical member; and
a second washer disposed between rear ends of said outer cylindrical member and the internal gear and the end of the yoke of said motor, said second washer being urged by the end of the yoke to place the front ends of the internal gear and said outer cylindrical member in constant abutment with a surface of the inner shoulder through said first washer.

20. A starter as set forth in claim 19, wherein said second washer works to bear a backward thrust load, as transmitted from said starter output shaft to support pins which support the planet gears rotatably and extend from an outer of said one-way clutch backward in an axial direction of said one-way clutch.
